(19) United States
(12) Patent Application Publication
(10) Pub. No.: US 2010/0316253 A1
(43) Pub. Date: Dec. 16, 2010

(54) PERVASIVE SENSING

(76) Inventors: Guang-Zhong Yang, Clarenden Park (GB); Benny Ping Lai Lo, London (GB)

Correspondence Address: HICKMAN PALERMO TRUONG & BECKER, LLP, 2055 GATEWAY PLACE, SUITE 550, SAN JOSE, CA, 95110, US

(21) Appl. No.: 12/445,722

(22) PCT Filed: Oct. 11, 2007
(86) PCT No.: PCT/GB07/03861

§ 371 Date: Apr. 15, 2009

(30) Foreign Application Priority Data
Oct. 17, 2006 (GB) 0620620.5

(51) Int. Cl. G06K 9/00

(52) U.S. Cl. 382/103

(57) ABSTRACT

A method of electronically monitoring a subject, for example in a home care environment, to determine the presence of the subject in zones of the environment as a function of time includes fusing data from image and wearable sensors. A grid display for displaying the presence in the zones is also provided.

### BENEFIT CLAIM

This application is a national stage entry in the United States under 35 U.S.C. 371 and claims the benefit under 35 U.S.C. 365 of Patent Cooperation Treaty (PCT) international application PCT/GB2007/003861, filed 11 Oct. 2007, and claiming priority to UK (GB) application 0620620.5, filed 17 Oct. 2006, the entire contents of which are hereby incorporated herein by reference for all purposes as if fully set forth herein.

### TECHNICAL FIELD

This invention relates to systems and methods for pervasive sensing, for example in a home care environment or more generally tracking people or objects in an environment such as a hospital, nursing home, building, train or underground platform, playground or hazardous environment.

### BACKGROUND

The miniaturisation and cost reduction brought about by the semiconductor industry have made it possible to create integrated sensing and wireless communication devices that are small and cheap enough to be ubiquitous. Integrated micro-sensors no more than a few millimetres in size, with onboard processing and wireless data transfer capability are the basic components of such networks already in existence. Thus far, a range of applications have been proposed for the use of wireless sensor networks and they are likely to change many aspects of our daily lives. One example of such applications is in using sensor networks for home care environments. For the elderly, home-based healthcare encourages the maintenance of physical fitness, social activity and cognitive engagement to function independently in their own homes. It could also provide a more accurate measure to care professionals of how well that person is managing, allowing limited human carer resources to be better directed to those who need care. The potential benefit to the individual is that they could enjoy an increased quality of life by remaining within their own homes for longer, if that is their preferred choice.

The deployment of sensor networks in a home environment, however, requires careful consideration of user compliance and privacy issues. The sensor nodes need to be small enough to be placed discreetly in appropriate locations and they need to be installed easily and to operate for extended periods of time with little or no outside intervention. To this end, current approaches are focussed on the use of contact, proximity, and pressure sensors on doors, furniture, beds and chairs to detect the activity of the occupants. Other sensors designed for sensing appliance usage, water-flow and electricity usage have also been proposed. See for example [Barnes, N. M.; Edwards, N. H.; Rose, D. A. D.; Garner, P., “Lifestyle monitoring-technology for supported independence,” Computing & Control Engineering Journal, vol. 9, no. 4, pp. 169-174, August 1998] herewith incorporated herein by reference. The devices provide the basic information that can be used to build a holistic profile of the occupant's well-being, but in an indirect sense. With these ambient sensors, however, very limited information can be inferred, and the overwhelming amount of sensed information often complicates its interpretation.

The main limitation of ambient sensing with simple sensors is that it is difficult to infer detailed changes in activity and those physiological changes related to the progression of disease. In fact, even for the detection of simple activities such as leaving and returning home, the analysis steps involved can be complex even by the explicit use of certain constraints. It is well known that even subtle changes in behaviour of the elderly or patients with chronic disorders can provide telltale signs of the onset or progression of the disease. For example, research has shown that changes in gait can be associated with early signs of neurologic abnormalities linked to several types of non-Alzheimer's dementias [Verghese J, Lipton R. B., Hall C. B., Kuslansky G, Katz M. J., Buschke H. Abnormality of gait as a predictor of non-Alzheimer's dementia. N Engl J Med, vol. 347, pp 1761-8, 2002]. Unstable gait can be a major factor contributing to falls and some of them can be fatal. For the patient, consequences may include fracture, anxiety and depression, loss of confidence, all of which can lead to greater disability.

Video sensors, particularly of the kind referred to below as blob sensors, which can be used to form a sensor network for the homecare environment based on the concept of using abstracted image blobs to derive personal metrics and perform behaviour profiling have been described in [Pansiot J., Stoyanov D., Lo B. P. and Yang G. Z., “Towards Image-Based Modeling for Ambient Sensing”, In the IEEE Proceedings of the International Workshop on Wearable and Implantable Body Sensor Networks 2006, pp. 195-198, April 2006], referred to as Pansiot et al below and herewith incorporated herein by reference. In brief a blob sensor immediately turns captured images into blobs that encapsulate shape outline and motion vectors of the subject at the device level. The blob may simply be an ellipse fitted to the image outline (see [Jeffrey Wang, Benny Lo and Guang Zhong Yang, “Ubiquitous Sensing for Posture/Behavior Analysis”, IEE Proceedings of the 2^{nd} International Workshop on Body Sensor Networks (BSN 2005), pp. 112-115, April 2005] referred to as Wang et al below and herewith incorporated herein by reference) or a more complicated shape may be used. No visual images are stored or transmitted at any stage of the processing. Furthermore, it is not possible to reconstruct this abstracted information into images, ensuring privacy.

Wearable sensors, in particular for use in a home care environment have been developed which can be used for inferences about a wearer's activity or posture and are described in [Farringdon J., Moore A. J., Tilbury N., Church J., Biemond P. D., Wearable Sensor Badge and Sensor Jacket for Context Awareness,” In the IEEE Proceedings of the Third International Symposium on Wearable Computers, pp. 107-113, 1999], [Surapa Thiemjarus, Benny Lo and Guang-Zhong Yang, “A Spatio-Temporal Architecture for Context-Aware Sensing”, In the IEEE Proceedings of the International Workshop on Wearable and Implantable Body Sensor Networks 2006 pp. 191-194, April 2006] (referred to as Thiemjarus et al below) and in co-pending patent application GB0602127.3, all herewith incorporated herein by reference.

### SUMMARY OF DISCLOSURE

The invention is set out in the independent claims. Further, optional aspects of embodiments of the invention are described in the dependent claims.

Advantageously, by combining the signals of image and wearable sensors, a subject wearing a wearable sensor can be linked to a candidate subject detected by the image sensor. Thus, the subject can be tracked while moving through an environment and the presence in a given zone of the environment may conveniently be displayed in a zone-time grid. A corresponding state vector representation may be analysed using time-series analysis tools.

### BRIEF DESCRIPTION OF DRAWINGS

Embodiments of the invention are now described by way of example only and with reference to the accompanying drawings in which:

FIG. 1 depicts a schematic diagram of a pervasive sensing environment;

FIG. 2 depicts a graphical display representative of an activity matrix indicating activity with in the sensing environment;

FIG. 3 depicts three exemplary images sensed by a blob sensor;

FIGS. 4a and b depict activity signals derived from two blob sensors;

FIG. 5 depicts acceleration signals derived from a wearable sensor associated with the activity signals of FIG. 4a;

FIG. 6 depicts a schematic representation of sensor fusion;

FIG. 7 depicts an activity index; and

FIG. 8a-c depict exemplary activity matrices.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description which follow are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

In overview, the embodiments described below provide an integrated wearable and video based pervasive sensing environment for tracking of, for example, human blobs in image sequences, which can be analysed to give information specific to the monitored. This information is referred to as a personal metric.

In, for example, a homecare sensing environment, the personal metrics may be transmitted between sensors so behaviour profiling may be performed in a distributed manner using the inherent resources of multiple sensor nodes or the metrics may be transmitted to a central processing facility (or a combination of both). The transmitted information may used to measure personal metric variables from individuals during their daily activities and observe deviations of e.g. physiological parameters gait, activity and posture as early as possible to facilitate timely treatment or automatic alerts in emergency cases. As described in more detail below, by fusing information from the wearable on-body sensors and the ambient video blob sensors, a personal activity metric may be derived, which may provide concise information on the daily activity and well-being of the subject. Changes in the activity or well-being may be identified using the metric.

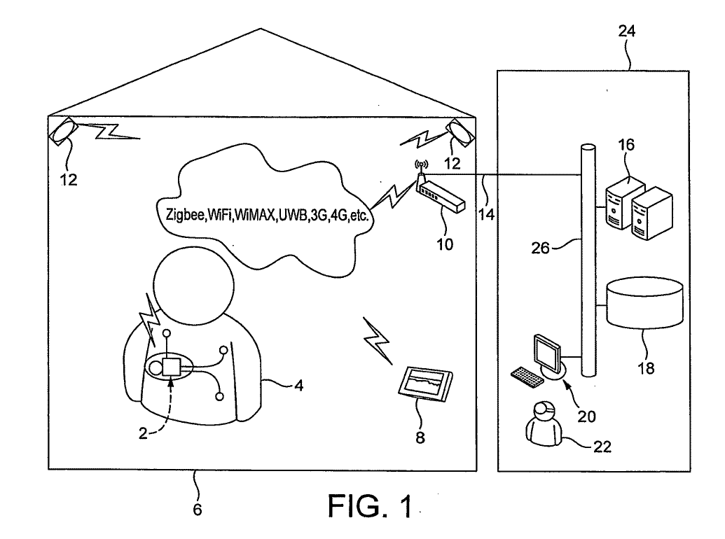

With reference to FIG. 1, depicting schematically a system of a combined blob wearable sensor pervasive sensing environment, an on-body or wearable sensor 2 is worn, for example behind the ear, by a subject 4 inside a room or zone 6 (for example in a home). The sensor 2 may be in wireless communication with a home gateway 10. Wireless communication can be established using any suitable protocol, for example ZigBee, WiFi, WiMAX, UWB, 3G or 4G. One or more blob sensors 12 are positioned within the room 6 so as to image the area of the room. The blob sensors 12 may also be in wireless communication with the gateway 10. Use of further ambient sensors such as contact or pressure sensors is also envisaged.

The captured data is transmitted to a central processing facility or care centre 24 providing a central server 16 via the gateway 10 and a communications network 14. The centre 24 also provides data storage housing a database 18 and a workstation 20 providing a user interface for a care professional 22. The components of the care centre 24 are interconnected, for example by a LAN 26. A further user interface 8 may be provided in the room 6, for example using a wireless device.

In addition to or in place of processing and the central processing facility, data may be processed in a distributed fashion by the sensor itself, using wireless connections between the wearable sensors and the blob sensors 12 to distribute data processing. The blob sensor or sensors may use wireless communication to link to the wearable sensors, and may use either a wired or wireless link between the sensor nodes and the gateway station. Equally, some of the processing may be carried out by the further user interface 8.

The home gateway 10 may be implements as a home broadband router which routes the sensed data to the care centre. In addition to routing data, data encryption and security enforcement may be implemented in the home gateway 10 to protect the privacy of the user. To provide the necessary data processing, the home gateway 10 may be integrated with the further user interface 8. The home gateway may use any of the existing connection technologies, including standard phone lines, or wireless 3G, GPRS, etc.

Upon receiving the sensing information from the home gateway, the central server 16 may store the data to the database 18, and may also perform long-term trend analysis. By deriving the pattern and trend from the sensed data, the central server may predict the subject's condition so as to reduce the risk of potentially life-threatening abnormalities. To enable trend analysis, the database 18 may be used to store all the sensed data from one or more subjects, such that queries on the subject's data can be performed by the care taker 22 using the workstation 20. The workstation 20 may include portable handheld devices (such as a mobile telephone or email client), personal computers or any other form of user interface to allow care takers to analyze a subject's The subjects' real-time sensor information, as well as historical data, may also be retrieved and played back to assist diagnosis and/or monitoring.

The wireless wearable on-body sensors 2 may be used to monitor the activity and physiological parameters of the subject 4. For example, the wearable sensor 2 may include an earpiece to be worn by the subject which includes a means for sensing three directions of acceleration, for example a three-axis accelerometer.

Depending on the physical state of the subject, different sensors can be used to monitor different parameters of the subject. For example, a MEMS based accelerometer and/or gyroscope may be used to measure the activity and posture of the subject. ECG sensors may be used to monitor cardiac rhythm disturbances and physiological stress. A subject may wear more than one wearable sensor. All on-body sensors 2 have a wireless communication link to one or more of the blob (or other wearable) sensors, the further user interface, and the home gateway.

In one particular implementation, the wearable sensor includes an earpiece which houses the following: a Texas Instruments (TI) MSP430 16-bit ultra low power RISC processor with 60 KB+256 B Flash memory, 2 KB RAM, 12-bit ADC, and 6 analog channels (connecting up to 6 sensors). The acceleration sensor is a 3-D accelerometer (Analog Devices, Inc: ADXL102JE dual axis). A wireless module has a throughput of 250 kbps with a range over 50 m. In addition, 512 KB serial flash memory is incorporated for data storage or buffering. The earpiece runs TinyOS by U.C. Berkeley, which is a small, open source and energy efficient sensor board operating system. It provides a set of modular software building blocks, of which designers could choose the components they require. The size of these files is typically as small as 200 bytes and thus the overall size is kept to a minimum. The operating system manages both the hardware and the wireless network, taking sensor measurements, making routing decisions, and controlling power dissipation.

The wearable sensors may be used for on-sensor data processing or filtering, for example as described in co-pending application PCT/GB2006/000948, incorporated herein by reference herewith, which describes classification of behaviour based on acceleration data from wearable sensors which may be done in an embedded fashion using the hardware of the sensors.

One embodiment of the blob sensor 12 has been described above and in Pansiot et al but briefly, it is an image sensor that captures only the silhouette or outline of subject(s) present in the room. Such a sensor may be used to detect the room occupancy as well as basic activity indices such as the global motion, posture and gait, as described in [Ng, J. W. P.; Lo, B. P. L.; Wells, O.; Sloman, M.; Toumazou, C.; Peters, N.; Darzi, A.; and Yang, G. Z. “Ubiquitous monitoring environment for wearable and implantable sensors” (UbiMon). In Sixth International Conference on Ubiquitous Computing (Ubicomp). 2004], herewith incorporated herein by reference.

The shape of a blob (or outline) detected by the sensor depends on the relative position of the subject and the sensor. A view-independent model can be generated by fusing a set of blobs captured by respective sensors at different known positions, which can be used to generate a more detailed activity signature. To ease the calibration and configuration of the sensor, a multi-dimensional scaling algorithm can be used to self-calibrate the relative position of these sensors. These techniques are described in Pansiot et al and also in [Doros Agathangelou, Benny P. L. Lo and Guang Zhong Yang, “Self-Configuring Video-Sensor Networks”, Adjunct Proceedings of the 3^{rd} International Conference on Pervasive Computing (PERVASIVE 2005), pp. 29-32, May 2005], herewith incorporated herein by reference.

Further details of how the image outlines or blobs can be derived from the video signal can be found in [Jeffrey Wang, Benny Lo and Guang Zhong Yang, “Ubiquitous Sensing for Posture/Behavior Analysis”, IEE Proceedings of the 2^{nd} International Workshop on Body Sensor Networks (BSN 2005), pp. 112-115, April 2005], herewith incorporated by reference herein. With the use of more than one image sensor, the merging of signals from multiple sensors is described in [Q. Caiand J. K. Aggarwal, “Tracking Human Motion Using Multiple Cameras”, Proc. 13th Intl. Conf. on Pattern Recognition, 68-72, 1996] and [Khan, S.; Javed, O.; Rasheed, Z.; Shah, M., “*Human tracking in multiple cameras”, Proceedings of the Eighth IEEE International Conference on Computer Vision 2001 (ICCV 2001), Vol, 1, pp. 331-336, July 2001], herewith incorporated by reference herein.

By using three or more blob sensors per zone or room the three-dimensional position of the subject in the zone or room can be estimated. For this functionality, the sensor network needs to be calibrated such that the internal sensor characteristics and the relative spatial arrangement between the devices are known [Richard Hartley and Andrew Zisserman, Multiple View Geometry in Computer Vision, Cambridge University Press, 2004], herewith incorporated by reference herein.

Then with the blob information computed at each sensor it is possible to find the position in 3D space most likely to be occupied by the subject. This process requires multiple view triangulation when using a single line of sight or the construction of a visual hull when making use of the full blob outline [Danny B. Yang, Gonzalez-Banos Gonzalez-Banos, Leonidas J. Guibas, “Counting People in Crowds with a Real-Time Network of Simple Image Sensors”, IEEE International Conference on Computer Vision (ICCV '03), vol. 1, pp. 122-130, 2003], herewith incorporated by reference herein. See also [Anurag Mittal and Larry Davis, “Unified Multi-Camera Detection and Tracking Using Region-Matching”, IEEE Workshop on Multi-Object Tracking, 2001] for the calculation of position from multiple cameras.

To facilitate the interpretation of the information, an activity matrix may be derived by combining the information from on-body sensors and the information from blob sensors. Instead of showing detailed sensing information as in other homecare systems (see for example [E. Munguia Tapia, S. S. Intille, and K. Larson, “Activity recognition in the home setting using simple and ubiquitous sensors,” in Proc. PERVASIVE 2004, A. Ferscha and F. Mattern, Ed. Berlin, Heidelberg, Germany, vol. LNCS 3001, 2004, pp. 158-175.]), the activity matrix provides a spatial illustration of the activity in the subject's home. From the activity matrix, the daily activity routine may be inferred, and it also provides a means of measuring the social interactions of the subject. In addition, if required, detailed sensing information can also be retrieved using a graphical user interface which displays the activity matrix, for example on the further user interface 8 or the work station 20.

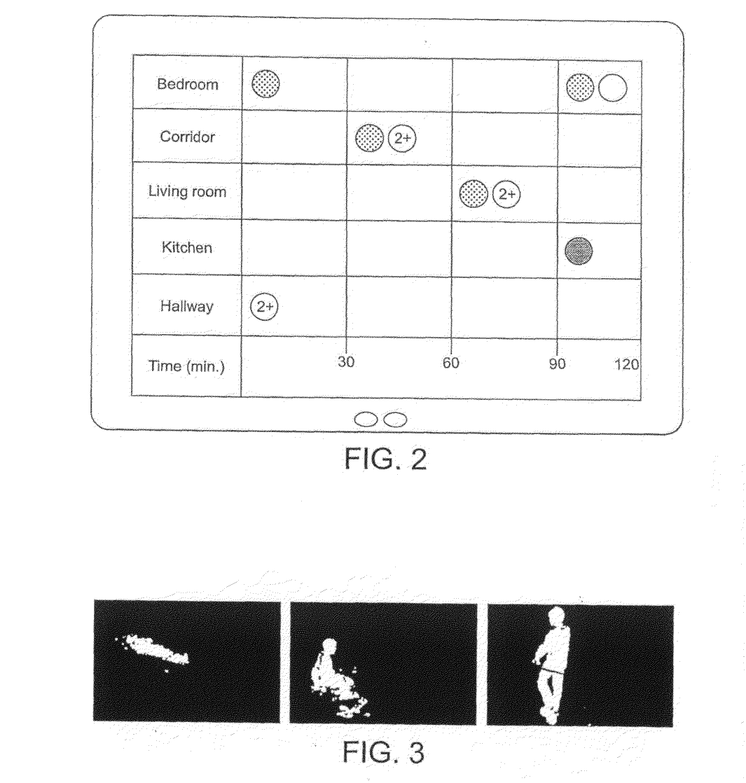

With reference to FIG. 2, activity matrices derived, for example, by linking wearable sensors and video based blob sensors show a graphical representation of the behaviour and interaction of the subject being sensed, although analysis based on the blob sensors alone or the wearable sensor alone using radio telemetry to estimate position is also envisaged. The horizontal axis of the matrix represents time with a predefined interval for each cell. The vertical axis shows the zones (for example rooms) covered by the blob sensors, that is video or image sensing zones. The hexagon marker shows the subject being monitored, whereas other, differently shaped or coloured markers signify visitors or other occupants. If more subjects than can be displayed in a cell of the matrix are detected, a different marker representation may be used indicating the number of subjects present, for example by a numerical value being displayed. If more than one subject is tracked using a wearable sensor, different geometric symbols may be used for the different subjects. The zones may correspond to rooms of a home or may have a higher level of granularity, for example areas within a room such as “armchair”, “shelf”, “door”, etc. This higher level of detail may be provided as a second layer displayed when a high level zone (e.g. “bedroom”) is interactively selected, thereby providing a multi-resolution display.

The graphical interface shows the number of users per zone or room in the patient's house across time. The screen is automatically updated, for example every few seconds and may scroll across time. This interface provides a summary of the interaction of the occupant with other people. For example, the example show in FIG. 2 can represent two carers arriving at a patients home and after which one carer attends to the patient in the bedroom while another works in the kitchen.

It is understood that the display interface described above may be used more generally, whenever it is necessary to display the presence of a subject within a given spatial zone and within a given time interval.

The determination of the location of the occupant is achieved by fusing information from the blob sensors and wearable sensors. The algorithm permits the system usage under single and multiple occupancy scenarios. With the use of wearable sensors, multiple, specific subjects identified by their wearable sensor or sensors can also be identified and tracked simultaneously. Subjects detected by the blob sensors who do not wear a on-body sensor can be detected in each room but not identified.

For tracking to work as discussed above with reference to FIG. 2, it is important to determine which, if any, one of the blobs detected by the blob sensor belongs the subject 4 wearing the wearable sensor 2. To this end, correlation or some other form of comparison of the signals from both types of sensors is used as described in more detail below. This is also the case if more than one subject is wearing a wearable sensor to determine which blob belongs to which of these subjects. Because the wireless communication network used between the wearable sensors and the remainder of the systems, wearable sensors that are not in the line of sight but within the wireless transmission range of the wireless communication system in the zone of the image sensor will be detected for that zone. Therefore, even if there is only a single subject wearing a wearable sensor, identifying and tracking that subject in the presence of other subject (not wearing a sensor) also requires comparison between the signals from the blob and wearable sensors.

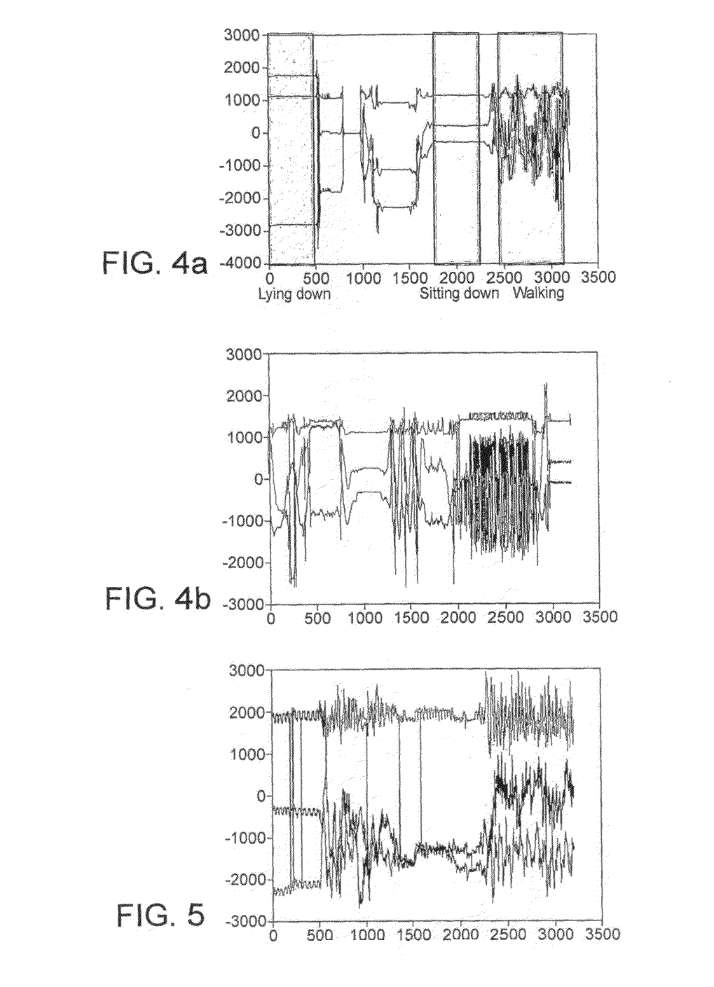

With reference to FIG. 3, an example sequence of blob sensor raw signals includes a sequence of blobs or outlines of a subject, from which positional data may be derived as described above. A three-dimensional position signal derived from a blob sensor is depicted in FIG. 4a (against samples, sampling rate 50 Hz). The time windows shaded in FIG. 4a correspond to the three outlines shown in FIG. 3. FIG. 5 depicts acceleration data from a wearable sensor corresponding to the sequence in FIG. 4a (against samples, sampling rate 50 Hz).

As can be seen from FIGS. 4a, b and 5, the acceleration data in FIG. 5 undergoes major changes at the same time as the position data in FIG. 4a, while the position data in FIG. 4b which is derived from a different blob changes at different times. Thus data from one and the same subject will tend to undergo major changes at about the same time and this forms the basis of a robust similarity measure to determine the blob which corresponds to a given wearable sensor.

For example, the sampled data may be windowed with, for example, 1 second windows and the average signal level calculated within each window for each of the three spatial components of the signals. When the windowed average changes by more than a threshold value, for example 40%, from one window to the next, a corresponding entry in a change vector (with entries corresponding to the time windows and initialised to zero) can be marked with a non-zero value, for example 1. Similarity between the signal from the blob sensor and the wearable sensor can then be determined by determining the similarity of the corresponding change vectors recorded over a given time interval (for example a minute), for example using correlation or a dot product between the two vectors to determine similarity. Of course, any other measure of calculating the similarity between two vectors may also be applied. Direct logic comparisons between times at which changes occur for each of the subjects are also envisaged to establish similarity.

Based on the comparison, each wearable sensor (which is associated with a subject) is continuously matched to a blob as the subject moves from zone to zone. For example, the position collected from the blob sensors and acceleration data from the wearable sensors may be used in the similarity analysis described above to find a blob matching the subject. Other activity signals derivable from the sensors may also be used. Similarly, any other suitable technique for fusing the signals from the blob and wearable sensor may also be used, for example Bayesian Networks or Spatio-Temporal SOM's (see Thiemjarus et al).

The activity signal may also be of a more abstract nature, for example it may be the result of a classification into discrete behaviours such as “lying down”, “standing up”, “walking”, etc, based on the sensor signals. Examples of the derivation of such more abstract signals (indicating a category of behaviour at sample time points) are described in Wang et al for the image sensor and in Thiemjarus et al and also [Surapa Thiemjarus and Guang Zhong Yang, “Context-Aware Sensing”, Chap. 9 in Body Sensor Networks, London: Springer-Verlag, 2006.], herewith incorporated by reference herein, for multiple on-body acceleration sensors. These activity signals may then be compared, for example using correlation, to determine the similarity between the signals derived using the data from the image sensor and on-body sensor, respectively.

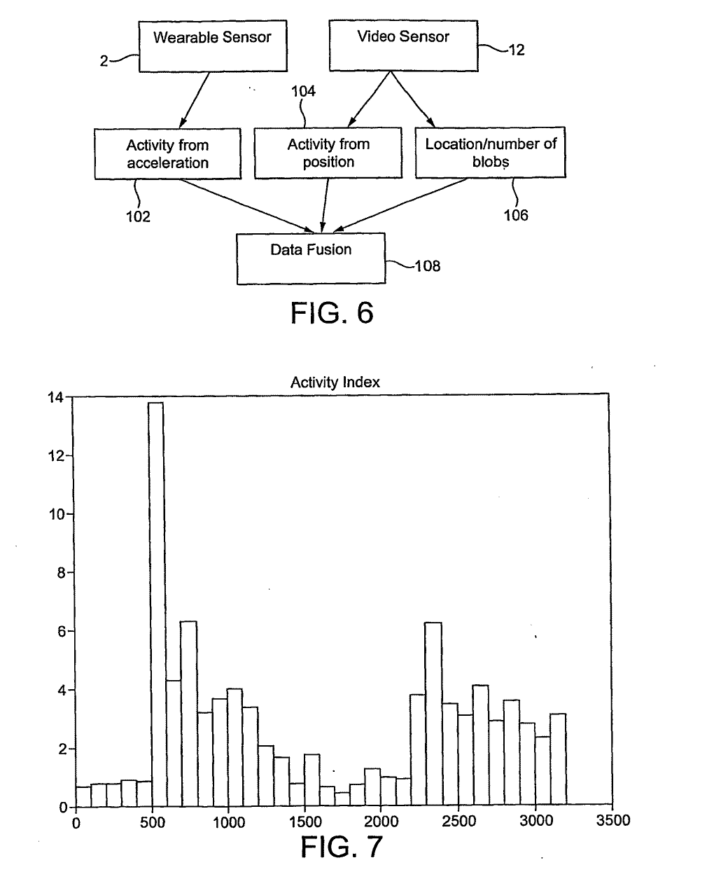

With reference to FIG. 6, an activity related signal (e.g. acceleration) 102 derived from the wearable sensor 2 is fused by data fusion means 108 with an activity related signal (e.g. position) 104 from the blob sensors 12 for each of the blobs, as well as a signal 106 representative of the blobs' location. This may simply be the room in which the sensor is installed or a more specific location may be determined based on the blob position derived. In a specific embodiment, the fusion means 108 compares the two activity signals as described above and marks the blob whose associated activity signal is found to be most similar with the activity signal derived from the wearable sensor. From the marked blob's location a state-vector can be derived at each sample time indicating in which zone a subject wearing a given wearable sensor is present. A sequence of these state vectors can then be displayed graphically as shown in FIG. 2 and described above. Unmarked blobs can also be displayed in the same way and give an indication of the social interaction of the subject.

The graphical interface described above with reference to FIG. 2 may provide a multi-resolution format, i.e. by clicking on a cell of the display, further details of the activity of the subject within the video sensing zone and time interval of each cell can be revealed. Furthermore, the display can also toggle to a detailed activity index as calculated from the movement of the video blob or from the signal from the accelerometers. For example, this can include an index showing the level of activity calculated as the averaged (over dimensions) variances of the three-dimensional acceleration signal from the wearable sensor. The index varies between 0 (for sleeping, no motion) to a higher value showing a higher activity level (such as running) Normal activities are in between. The activity index corresponding to FIG. 4 (b) is illustrated in FIG. 6. As described above, the display may also be toggled to a higher spatial and/or temporal resolution.

The activity matrix shown in FIG. 2 (or more accurately its numerical representation as a sequence of state vectors with an entry of e.g. 1 indicating the presence of the monitored subject) provides ease of analysis and comparison of behaviour during different periods. As an example, FIG. 7a-c show example sequences demonstrating different patterns of activity of the subject being monitored. By comparing the last period in FIG. 7c, it can be easily picked out that the subject is using the toilet more frequently and for longer time intervals than in the other two periods in FIGS. 7 a and b. This may alert the health care professional 22 to the presence of digestive problems in the subject.

Defining the time windows (columns) of the graphical interface as a sequence of state vectors (e.g. by assigning a pre-defined numeric value such as 1 to each cell where the monitored subject is detected to be present), a transition matrix can be calculated. These transition matrices summarise the general motion of a person within the house and represent the probability of transition from one room to another. They also reflect the connectivity of the house as direct transition between some rooms may be impossible. Transition matrices can be calculated in a manner known to the person skilled in the art. By detecting differences in the transition probabilities of these matrices calculated over different time periods (e.g. on different days), abnormal behaviour can be detected and classified (in the above example an increased self transition probability and incoming transition probability for the toilet zone indicating digestive problems). One possible measure of this difference is to normalise the transition matrix with respect to a baseline matrix (representing normal behaviour) and to possibly calculate the absolute difference from 1 for the resulting values for each transition.

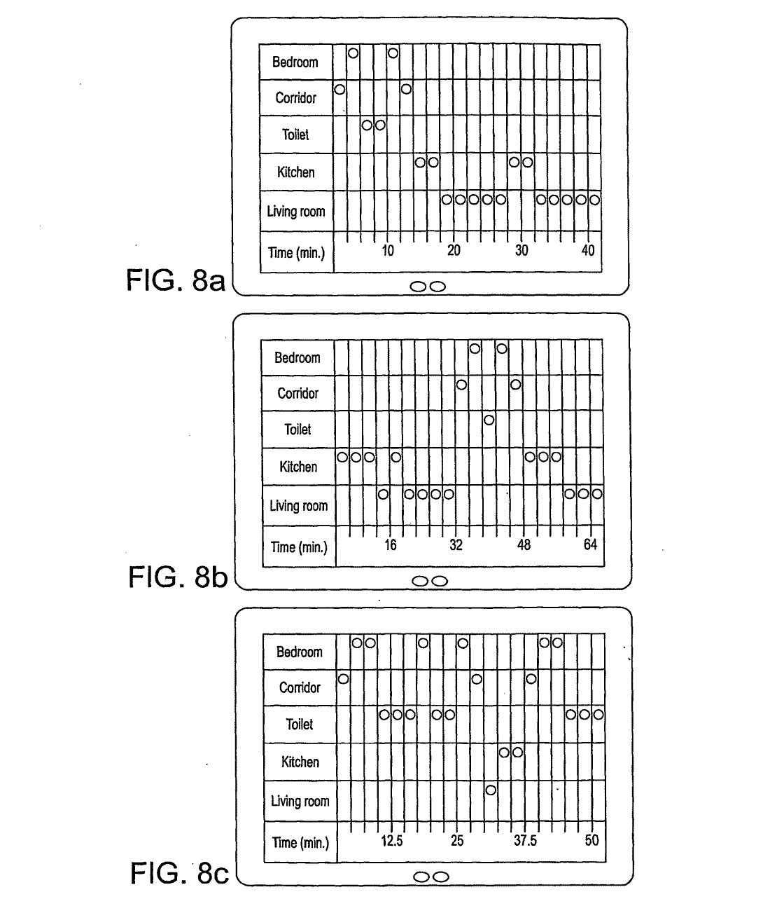

Another applicable similarity measure is the Earth Mover Distance (EMD), which measures the similarity between two groups of sequences or of one sequence with respect to a baseline sequence. In this work, these sequences represent the series of locations of the person being observed. The person skilled in the art will be familiar with this measure which is described in [L. Dempere-Marco, X.-P. Hu, S. Ellis, D. M. Hansell, G. Z. Yang, “Analysis of Visual Search Patterns with EMD Metric in Normalized Anatomical Space,” IEEE Transactions on Medical Imaging, vol. 25, no. 8, pp. 1011-1021, 2006] or [Y. Rubner, C. Tomasi, L. J. Guibas, A Metric for Distributions with Applications to Image Databases, Proceedings of the Sixth International Conference on Computer Vision, p. 59, Jan. 4-07, 1998], both herewith incorporated herein by reference. In the above example, EMD(b,a)=18 and EMD(c,a)=32, indicating that the sequence shown in FIG. 8(b) is more similar to that in FIG. 8(a) than the one in FIG. 8(c). Although the sequences are actually quite different, this measure finds a way of measuring similarity. It is understood that any suitable analysis technique for extracting behavioural conclusions from the activity matrix may also be applied.

Abnormal behaviour can then be detected as a deviation or dissimilarity from baseline and a corresponding alert can be issued.

It will, of course, be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

The above description is in terms of a subject being monitored, specifically in a health care setting. However, it will be understood that the invention is not limited in this respect and that the term subject as used herein encompasses both humans and non-human animals and further any inanimate object, for example those which displays patterns of activity that can be analysed as described above, for example a robot.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method of electronically monitoring a specific subject in a spatially defined zone including:
a) detecting the presence at a given time of a candidate subject within the zone using an image sensor;
b) fusing a first signal obtained using data from the image sensor and related to the candidate subject and a second signal obtained using data from a wearable sensor associated with the specific subject to determine whether the candidate subject is the specific subject; and
c) storing a digital record indicating the presence or absence of the specific subject within the zone at the given time based on the determination.

2. A method as claimed in claim 1 in which the first and second signals are temporal signals indicative of activity of, respectively, the candidate and specific subjects.

3. A method as claimed in claim 2 in which fusing the signals includes comparing them.

4. A method as claimed in claim 3 in which the comparing includes calculating respective first and second change signals representative of a change in the first and second signals and determining a measure of similarity between the first and second change signals.

5. A method as claimed in claim 4 in which calculating the change signals includes windowing the first and second signals into time windows, defining a change vector indexing the time windows and setting an element of the vector to a specific value if the change in the average from a corresponding and an adjacent time window exceeds a threshold.

6. A method as claimed in claim 1 including repeating a) to c) for a plurality of given times in an environment including a plurality of zones and storing a set of digital records indicating at each point in time in which zone the specific subject is present.

7. A method as claimed in claim 6 including analysing the set by comparing it to a baseline set and detecting differences between the sets.

8. A method as claimed in claim 7 including calculating a transition matrix between zones for each set and comparing the transition matrices.

9. A method as claimed in claim 7 including applying an Earth Mover Distance algorithm to each record.

10. A method as claimed in claim 5 including displaying the set in a graphical user interface including a plurality of cells arranged along a first axis representative of the given times or a subset thereof and a second axis representative of the zones or a subset thereof, each cell indicating the presence of the specific subject in a given zone at a given time by displaying a first marker in the corresponding cell.

11. A method as claimed in claim 10 including displaying the presence of a candidate subject other than the specific subject in a given zone at a given time by displaying a second, different marker in a cell corresponding to the said given zone and time.

12. A method as claimed in claim 1 in which the first signal is indicative of subject position and the second signal is indicative of subject acceleration.

13. A method as claimed in claim 1 in which the zones are part of a home care environment and the subjects are persons.

14. A method claimed in claim 1 in which images of the subjects are silhouettes.

15. A monitoring system for electronically monitoring a specific subject in a spatially defined zone including:
an image sensor;
a central processing facility;
a gateway for receiving data from a wearable sensor worn by the specific subject and the image sensor and transmitting it to the central processing facility;
wherein the central processing facility is adapted to implement
a) detecting the presence at a given time of a candidate subject within the zone using an image sensor;
b) fusing a first signal obtained using data from the image sensor and related to the candidate subject and a second signal obtained using data from a wearable sensor associated with the specific subject to determine whether the candidate subject is the specific subject; and
c) storing a digital record indicating the presence or absence of the specific subject within the zone at the given time based on the determination.

16. A system as claimed in claim 15 in which the image sensor is arranged to transmit only silhouettes of the subjects to the gateway.

17. A system as claimed in claim 15, the image sensor and gateway being installed in a home care environment.

18. A display interface for displaying the location of a monitored subject in a specific zone in an environment comprising a plurality of zones, including a plurality of cells arranged along a first axis representative of time intervals corresponding to the cells and a second axis representative of the zones, wherein the presence of the subject within a given zone at a given time is represented by displaying a first marker in the cell corresponding to the given zone and given time.

19. A display interface as claimed in claim 17, in which the cells are interactively selectable to display further information relating to the cells.

20. A display interface as claimed in claim 19 in which the further information is presented as a further display with a finer spatial or temporal resolution, or both.

21. A display interface as claimed in claim 19 in which, when the cell displaying the first marker is selected, the further information includes information derived from a wearable sensor worn by the specific subject.

22. A display interface as claimed in claim 21 in which the further information includes physiological measurements for the specific subjects.

23. A display interface as claimed in claim 21 in which the further information includes an activity index defined as the variance of a measured acceleration of the wearable sensor.

24. A display interface as claimed in claim 18 in which the presence of subjects other than the specific subject is displayed in corresponding cells using a different, second marker.

25. A method of monitoring the well-being of a subject being monitored in an environment including a plurality of zones, which includes:
storing a sequence of digital records indicating in which zone the subject is present at a plurality of sample times defining the sequence;
comparing the stored sequence to a baseline sequence representative of healthy behaviour;
issuing an alert if a deviation of the stored sequence from the baseline sequence is detected.

26. A method as claimed in claim 25 in which the comparing includes calculating an Earth Mover Distance.

27. A method as claimed in claim 25 in which the comparing includes calculating a transition matrix representative of movement between the zones.

28. A computer-readable medium encoding computer code instructions for implementing electronically monitoring a specific subject in a spatially defined zone including:
a) detecting the presence at a given time of a candidate subject within the zone using an image sensor;
b) fusing a first signal obtained using data from the image sensor and related to the candidate subject and a second signal obtained using data from a wearable sensor associated with the specific subject to determine whether the candidate subject is the specific subject; and
c) storing a digital record indicating the presence or absence of the specific subject within the zone at the given time based on the determination.

29. A computer system arranged to implement electronically monitoring a specific subject in a spatially defined zone including:
a) detecting the presence at a given time of a candidate subject within the zone using an image sensor;
b) fusing a first signal obtained using data from the image sensor and related to the candidate subject and a second signal obtained using data from a wearable sensor associated with the specific subject to determine whether the candidate subject is the specific subject; and
c) storing a digital record indicating the presence or absence of the specific subject within the zone at the given time based on the determination.

30. A system for monitoring a subject in a home care environment including one or more image sensors arranged to sense a silhouette of the subject and a wearable sensor arranged to be worn by the subject and to sense movement or physiological data from the subject; the system further including a central processing facility for combining and storing data received from the image and wearable sensor.
